(19) United States
(12) Patent Application Publication
(10) Pub. No.: US 2018/0284045 A1
(43) Pub. Date: Oct. 4, 2018

(54) Sensing Element for a Measurement System Suitable for Dielectric Impedance Spectroscopy

(71) Applicant: SIEMENS AG OESTERREICH, Wien (AT)

(72) Inventors: Martin JAHN, Eisgarn (AT); Martin SCHIEFER, St. Poelten (AT)

(21) Appl. No.: 15/766,055

(22) PCT Filed: Oct. 5, 2016
(86) PCT No.: PCT/EP2016/073723

§ 371 Date: Apr. 5, 2018

(30) Foreign Application Priority Data
Oct. 6, 2015 (AT) A 50850/2015

(51) Int. Cl. G01N 27/02

(52) U.S. Cl. CPC G01N 27/026

(57) ABSTRACT

A sensing element for a measurement system suitable for dielectric impedance spectroscopy, wherein the sensing element, at least in one operating state of the sensing element, includes at least a first one microstrip conductor, which has a first conductor strip for a measurement signal, a first dielectric substrate and a first ground surface, where the first conductor strip may be applied from the outside and over an area to a container containing a dielectric material sample to be measured.

### CROSS-REFERENCE TO RELATED APPLICATIONS

This is a U.S. national stage of application No. PCT/EP2016/073723 filed Oct. 5, 2016. Priority is claimed on Austrian Application No. A50850/2015 filed Oct. 6, 2016, the content of which is incorporated herein by reference in its entirety.

### BACKGROUND OF THE INVENTION

### 1. Field of the Invention

The present invention relates to a sensing element for a measurement system suitable for dielectric impedance spectroscopy, relates to a measurement system for dielectric impedance spectroscopy, comprising the sensing element and a device for generating and evaluating a measurement signal and/or a reference signal for the sensing element, and relates to a method for determining the impedance of a dielectric material sample contained in a container, preferably a dielectric suspension, via the measurement system.

### 2. Description of the Related Art

Many suspensions, such as those frequently found, for example, in the biotechnology and industrial sectors or also in oil exploration, are measured and characterized via dielectric impedance spectroscopy. This is often only possible by contact-based measurements, where the sensing element is brought into contact with the suspension to be measured, which increases the risk of contamination of the suspension, on the one hand, and/or the formation of an unwanted film on the sensor itself, on the other hand, which film is a hindrance to the measurement and any further measurements. In addition, measurements during which the sensor must be introduced into the suspension are usually complex and also difficult to automate.

Coaxial sensors, for instance, are known in this context which, on the one hand, allow a broadband measurement but, on the other hand, are also complex to handle, because they need to be immersed a certain distance into the suspension during the measurement.

In addition, measurement methods are known in which the material sample to be measured must be introduced into the interior of a waveguide (hollow conductor) or coaxial sensor, such that the material sample completely fills the interior. Measurement methods working with such sensors are therefore not practicable for suspensions although the measuring principle used, i.e., the utilization of the physical properties of “transmission lines”, would generally allow a very broadband measurement.

Another conventional measuring method, which is likewise not suitable for the measurement of suspensions due to its complexity, comprises a transmitter and a receiver, where the material sample to be measured is measured contactlessly by being irradiated with electromagnetic radiation in the microwave range. However, both the measurement setup and the execution of such a measurement become very complex.

Other methods of dielectric impedance spectroscopy also appear unattractive, in particular in connection with suspensions to be measured. These include induction measurement, measurement via a capacitor (parallel plate measurement) and also the measurement of a dielectric material sample in a resonator.

### SUMMARY OF THE INVENTION

In view of the foregoing, it is therefore an object of the present invention to provide a broadband sensing element for a measurement system suitable for dielectric impedance spectroscopy, where the sensing element is particularly suitable for measuring dielectric suspensions, i.e., without having to bring the sensing element directly into contact with the suspension to be measured when doing so.

This and other objects and advantages are achieved in accordance with the invention, in the case of a sensing element for a measurement system suitable for dielectric impedance spectroscopy, by the fact that at least in one operating state of the sensing element, the sensing element comprises at least one first microstrip conductor, consisting of a first conductor strip for a measurement signal, a first dielectric substrate and a first ground surface, where the first conductor strip can be applied from the outside and over an area to a container containing a dielectric material sample to be measured, preferably to a pipe, a vessel or a bag.

In the case of a microstrip conductor, a conductor strip is situated between the interface surfaces of two different dielectrics. In this situation, the one dielectric is usually formed by a dielectric substrate of a printed circuit board and the other by air. As a result, the one part of the electromagnetic field of the signal conducted in the conductor runs directly between the conductor strip and a ground surface of the printed circuit board and thus in the substrate of the printed circuit board, while the other part of the electromagnetic field extends into the other dielectric. On account of the differing permittivities of the two dielectrics, the phase velocity of the propagating electromagnetic wave above and below the conductor strip is different and a quasi-TEM mode is formed.

In accordance with the invention, at least in the operating state the sensing element comprises at least one microstrip conductor for a measurement signal. In this situation, one of the two dielectrics is formed by the dielectric material sample to be measured together with the container in which the material sample is located. By applying the sensor to the container from the outside it is therefore now possible to measure the container-material sample system via dielectric spectroscopy, i.e., without having to bring the sensing element directly into contact with the material sample, in particular with a suspension, when doing so.

If the suspension changes (be it at different positions of the applied sensing element along the outside of the container or a temporal change in the internal structure of the suspension while the position of the sensing element remains the same), then the permittivity of the suspension thus also changes, which is reflected in the change to be measured in the phase of the measurement signal after passing through the conductor strip.

In this situation, the longer the conductor strip that is applied over an area of the container, the greater is the phase shift between the signal entering the sensing element and the signal exiting the conductor strip again after passing through the conductor strip. In other words, the more sensitive is the sensing element.

On account of the TEM mode produced, the sensing element in accordance with the invention is also particularly well suited for broadband measurements because TEM modes do not have a cut-off frequency.

In addition, a good signal-to-noise ratio can be achieved by using the microstrip conductor, which allows working with very high signal levels and which enables very accurate measurements.

The production of sensing elements in accordance with the invention is particularly simple and cost-effective (photolithographic production or by milling). As a result, the sensing element in accordance with the invention is in principle also suitable for single use.

In order to apply the sensing element with a precise fit to arbitrarily shaped containers, in a preferred embodiment of the sensing element in accordance with the invention the sensing element is configured to be flexible. In this case, the first conductor strip, the first dielectric substrate and the first ground surface have flexible configurations, i.e., bendable for instance.

In order to apply the sensing element with a precise fit to certain containers having a known form, in another preferred embodiment of the sensing element in accordance with the invention the sensing element is configured to be rigid, and curved at least sectionally. It is thereby possible to achieve an embodiment of the sensing element which is adapted to a curved or angular container but is at the same time rigid.

It should be understood that for a container having a correspondingly large flat outer surface a rigid flat sensing element can also be used.

In a further preferred embodiment of the sensing element in accordance with the invention, the first dielectric substrate is formed by a first printed circuit board, where the first printed circuit board has at least one first outer surface and a second outer surface arranged parallel to the first outer surface, and where the first conductor strip is arranged on the first outer surface and the first ground surface is arranged on the second outer surface.

This results in a particularly simple and uncomplicated design of the sensing element. The printed circuit board therefore serves, on the one hand, as the first dielectric substrate of the microstrip conductor and, at the same time, gives the sensing element its flexibility, if it is configured to be flexible, or serves as a forming element of a rigid sensing element, if it is configured to be rigid. A separate component of the sensing element, which forms the first dielectric substrate of the first microstrip conductor, is not necessary.

In order to enable a differential measurement of the phase velocity of the measurement signal or in order to be able to compare the phase of the measurement signal exiting the sensing element with the phase of a reference signal, the electromagnetic field of which is not propagated through the dielectric material to be measured, in a further preferred embodiment of the sensing element in accordance with the invention the sensing element comprises a second microstrip conductor that consists of a second conductor strip for a reference signal, a second dielectric substrate and a ground surface. Here, the ground surface of the second microstrip conductor can be formed by a separate additional ground surface. However, in order to keep the number of components required as low as possible and to keep the overall configuration of the sensing element as simple as possible, in a further preferred embodiment of the sensing element in accordance with the invention the ground surface of the second microstrip conductor is formed by the first ground surface.

In order to maintain the flexibility or the rigid form of the sensing element in this situation, in a further preferred embodiment of the sensing element in accordance with the invention the second dielectric substrate is formed by a second printed circuit board which can in turn be configured to be flexible in the case of a flexible sensing element or rigid in the case of a rigid sensing element.

In a particularly preferred embodiment of the sensing element in accordance with the invention, the first printed circuit board and the second printed circuit board each form a layer of a two-layer printed circuit board, where the two layers of the two-layer printed circuit board are separated from each other by the first ground surface.

This means that the sensing element consists of a single two-layer printed circuit board which, depending on the configuration of the first and second printed circuit boards, can itself be flexible or rigid, between the layers of which the first ground surface is arranged, and on the outer surfaces of which, facing away from each other and running parallel to the first ground surface, a conductor strip is arranged in each case.

In another preferred embodiment of the sensing element in accordance with the invention, the first conductor strip and the first ground surface are arranged beside each other on the same outer surface of a flexible printed circuit board and the first dielectric substrate in the operating state of the sensing element is formed by the container together with the dielectric material sample to be measured contained therein. Particularly in conjunction with cylindrical containers, this embodiment has the advantage that it can be applied sectionally surrounding the container. In accordance with the contemplated embodiments of the invention, a fastening mechanism can also be provided in order to secure the sensing element permanently to the container. Overall, a simple and quick installation of the sensing element is enabled by such an embodiment of the sensing element.

In order to also be able to compare the measurement signal with a reference signal in the case of such a preferred embodiment, in a further preferred embodiment of the sensing element in accordance with the invention a second conductor strip is arranged on an outer surface of the same section of the flexible printed circuit board, where the outer surface extends parallel to and is situated opposite the first ground surface, and where the second conductor strip covers the first ground surface.

In order to also keep the number of components of the sensing element as low as possible in this case, in a further preferred embodiment of the sensing element in accordance with the invention the second conductor strip, the first ground surface and the section of the flexible printed circuit board arranged between the second conductor strip and the first ground surface form a second microstrip conductor.

In order to maximize the path which the reference signal must travel along the container, in a further preferred embodiment of the sensing element in accordance with the invention that the first conductor strip and/or the second conductor strip is/are formed in a meandering shape. With this, on the one hand, the sensitivity of the sensing element is increased and, on the other hand, this arrangement of the conductor strip also increases the broadband capability of the sensing element because it is also possible to operate the sensing element with particularly low-frequency signals.

It is also an object of the invention to provide a measurement system for dielectric impedance spectroscopy, comprising a sensing element in accordance with disclosed embodiments and a device for generating and evaluating a measurement signal, or a measurement signal and a reference signal for the sensing element.

It is also an object of the invention to provide a method for determining the impedance of a dielectric material sample contained in a container, preferably a dielectric suspension, via the measurement system in accordance with the invention, where the method comprises the establishment of contact between the sensing element and the container by applying a first conductor strip provided for a measurement signal from the outside and over an area to the container, the supply of a measurement signal with a given frequency entering the sensing element, the measurement of the measurement signal exiting the sensing element, the determination of the phase shift between the entering and exiting measurement signals, and the determination of the impedance of the dielectric material sample held in the container from the phase shift between the entering and exiting measurement signals.

In order to also enable the differential determination in this case of the phase shift or of the phase velocity of the measurement signal relative to that of a reference signal which is propagating uninfluenced, in a particularly preferred embodiment of the method in accordance with the invention in addition to the incoming measurement signal an incoming reference signal having the same frequency is also fed into a second conductor strip of the sensing element provided for the reference signal, and subsequently the difference between the phase shift exhibited by the exiting measurement signal in relation to the incoming measurement signal and the phase shift exhibited by the exiting reference signal in relation to the incoming reference signal is determined.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be explained in greater detail with reference to exemplary embodiments. The drawings are exemplary and are intended to illustrate the character of the invention, but do not in any way restrict it or represent it conclusively, in which:

FIG. 1 shows a schematic view of a sensing element in accordance with the invention having a first microstrip conductor;

FIG. 2 shows a schematic view of a first exemplary embodiment of a sensing element in accordance with the invention having a first and a second microstrip conductor;

FIG. 3 shows a schematic view of a second exemplary embodiment of a sensing element in accordance with the invention, the first conductor strip and ground surface of which are arranged on the same outside of a flexible printed circuit board;

FIG. 4 shows a side view of the exemplary embodiment from FIG. 3, in accordance with the section line A-A;

FIG. 5 shows a view of a sensing element in accordance with the invention in accordance with the first exemplary embodiment;

FIG. 6 shows a view of a sensing element in accordance with the invention in accordance with the second exemplary embodiment;

FIG. 7 shows a view of a sensing element in accordance with the invention in accordance with the second exemplary embodiment, which sensing element is applied to a cylindrical or tubular container; and

FIG. 8 is a flowchart of the method in accordance with the invention.

### DETAILED DESCRIPTION OF THE EXEMPLARY EMBODIMENTS

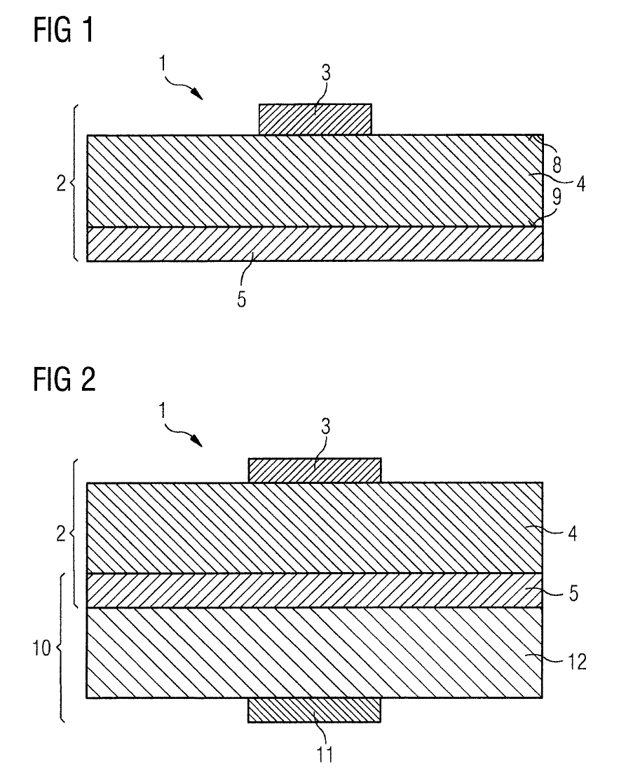

FIG. 1 shows the structure of a sensing element 1 in accordance with the invention. Here, the schematic structure illustrated of such a sensing element 1 comprises firstly a first printed circuit board 4. A first conductor strip 3 and a first ground surface 5 are arranged on opposite outer surfaces 8, 9 of the printed circuit board 4 and are connected to the printed circuit board 4. Together, the conductor strip 3, the first printed circuit board 4 and the first ground surface 5 form the first microstrip conductor 2 of the sensing element 1, where the first printed circuit board 4 forms a first dielectric substrate of the first microstrip conductor 2.

FIG. 2 shows the structure of a first specific exemplary embodiment of the sensing element 1 in accordance with the invention. The sensing element 1 of this exemplary embodiment comprises a first microstrip conductor 2 for a measurement signal and a second microstrip conductor 10 for a reference signal.

Here, the first printed circuit board 4 and a second printed circuit board 12 are separated from each other by a ground surface, which is formed by the first ground surface 5, and are connected to this ground surface. A first conductor strip 3 or a second conductor strip 11 respectively is arranged on an outer surface of the printed circuit board 4 or 12 respectively, where the outer surface extends parallel to the first ground surface 5.

The sensing element of the present exemplary embodiment thus consists of a first microstrip conductor 2, comprising the first conductor strip 3, the first printed circuit board 4 and the first ground surface 5, and of a second microstrip conductor 10, comprising the second conductor strip 11, the second printed circuit board 12 and the first ground surface 5.

Embodiments of the sensing element in accordance with the invention that have a structure in accordance with one of the two figures discussed above can be configured to be either flexible to be able to be applied with a precise fit to arbitrarily shaped containers, or to be rigid (for example, with one or two printed circuit boards embodied in rigid and curved fashion) to thereby be capable of being applied simply, quickly and repeatably to containers having a certain form.

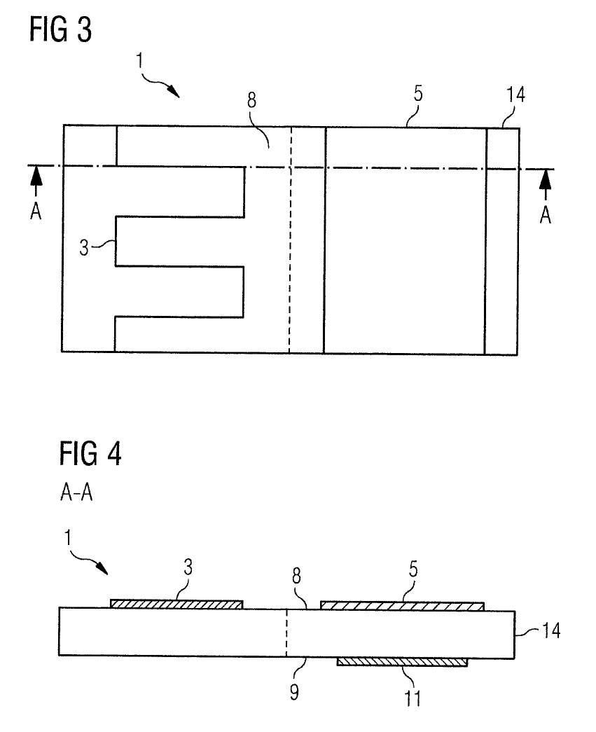

FIG. 3 shows the structure of a second specific exemplary embodiment of the sensing element 1 in accordance with the invention. In contrast to the above-described first exemplary embodiment, both the first conductor strip 3 and also the first ground surface 5 of this exemplary embodiment are arranged beside each other on the same outer surface 8 of a flexible printed circuit board 14. In this case, the present exemplary embodiment has a first conductor strip 3 arranged in a meandering shape. Here, the meandering arrangement of the first conductor strip 3 serves to extend the path along which the measurement signal must travel in the first conductor strip 3. Other arrangements that fulfill this purpose are also conceivable.

In the second exemplary embodiment, the first conductor strip 3 or the first ground surface 5 each occupy only a part of half of the outer surface 8, whereas embodiments in which the first conductor strip 3 and/or the first ground surface 5 each cover the entire half of the outer surface 8 are likewise conceivable and encompassed by the inventive idea.

FIG. 4 shows a sectional view of the sensing element 1 from FIG. 3, along the section line A-A. In this situation, the components belonging to the first microstrip conductor 2 and arranged on the one outer surface 8, i.e., the first conductor strip 3 and the first ground surface 5, can be seen. Arranged on a second outer surface 9 of the flexible printed circuit board 14 situated opposite the first outer surface 8 and (here extending parallel to the first ground surface 5) is a second conductor strip 11. In this case, the first ground surface 5 is separated from the second conductor strip 11 by a section of the flexible printed circuit board 14 and covers (seen here in the vertical direction) the second conductor strip 11.

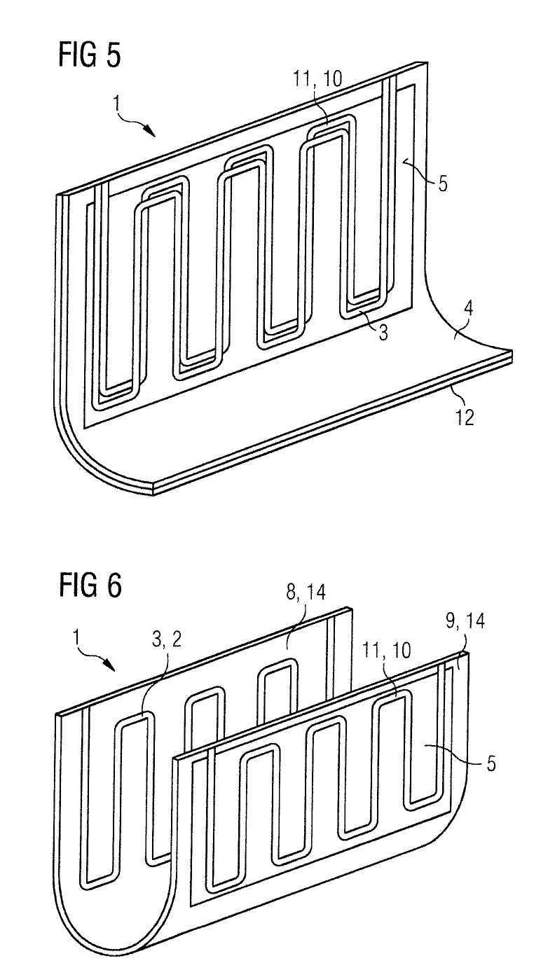

FIG. 5 shows the first exemplary embodiment of the sensing element 1 in accordance with the invention in a partially bent state. Here, the first printed circuit board 4 and the second printed circuit board 12, which printed circuit boards 4, 12 are configured to be flexible in the exemplary embodiment illustrated here, each form one layer of a two-layer flexible printed circuit board, where the two layers are separated from each other at least in sections by the first ground surface 5, which is likewise configured to be flexible.

A first conductor strip 3 and a second conductor strip 11 are arranged in the region of the first ground surface 5 on the two outer surfaces of the flexible printed circuit board extending parallel to the first ground surface 5. The sensing element of this present exemplary embodiment thus comprises the first microstrip conductor 2 and the second microstrip conductor 10, where the respective ground surface of the first microstrip conductor 2 and second microstrip conductor 11 is formed by one and the same ground surface, i.e., the first ground surface 5.

FIG. 6 shows the second exemplary embodiment of the sensing element in accordance with the invention, but not in a straight state of the flexible printed circuit board 14, as illustrated schematically in FIG. 3 and FIG. 4, but in a U-shaped bent state. In this case, the sensing element 1 has the first microstrip conductor 2, comprising the first conductor strip 3 and the first ground surface 5, and the second microstrip conductor 10, which second microstrip conductor 10 comprises the second conductor strip 11, the first ground surface 5 and the section of the flexible printed circuit board 14 situated between these two components.

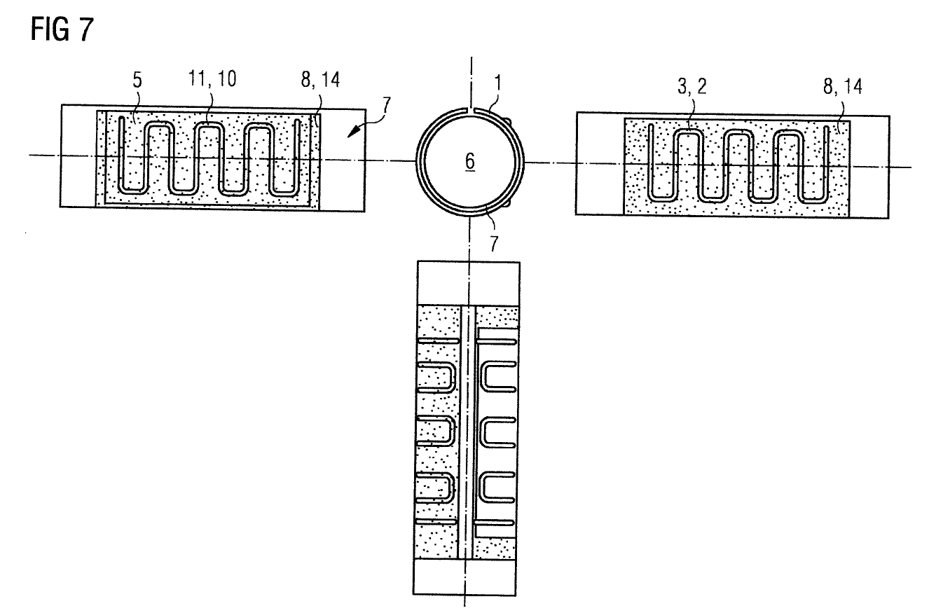

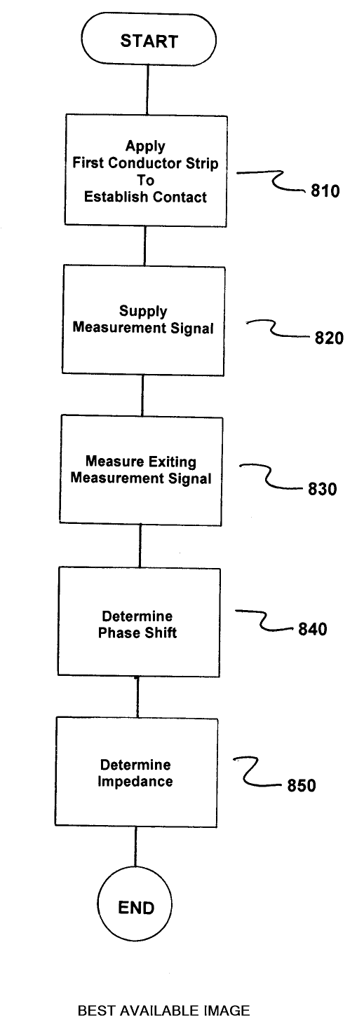

Lastly, FIG. 7 shows the sensing element 1 of the second exemplary embodiment (FIG. 6) in an operating state. In this case, the sensing element 1 is applied so as to circumferentially surround a cylindrical or tubular container 7. In a specific case, the container 7 in question is a pipe through which a suspension 6 flows.

In addition, three normal projections of the applied sensing element 1 are illustrated.

FIG. 7 provides a basis to describe the functioning of the invention in accordance with the second exemplary embodiment.

The embodiment of the sensing element 1 of the invention in accordance with the second exemplary embodiment has the advantage that the sensing element 1 can be applied circumferentially in a sleeve-like manner to a container 7, specifically to a pipe, or can be fitted thereto via a closing mechanism of the sensing element 1.

In the operating state of the sensing element 1 of the exemplary illustrated embodiment, the first microstrip conductor 2 comprises the first conductor strip 3, the first ground surface 5 and the system arranged between these two components consisting of container 7 and suspension 6 (referred to in the following as container 7, suspension 6 system), where the system forms the first dielectric substrate of the first microstrip conductor 2.

According to the theory of electrodynamics, an electrical signal conducted through the first conductor strip 3—and, in accordance with the invention, serving as a measurement signal—results in the fact that a part of the electromagnetic field that becomes established around the first conductor strip 3 runs directly between the first conductor strip 3 and the first ground surface 5 through the container 7-suspension 6 system. However, another part of the electromagnetic field extends into the flexible printed circuit board 14 upon which the first conductor strip is applied.

On account of the differing permittivities of the two dielectrics (i.e., the container 7, suspension 6 system) and the dielectric material from which the flexible printed circuit board 14 is produced, the electromagnetic field of the measurement signal propagates above and below the first conductor strip 3 at different phase velocities, which results in the formation of a transversal-electromagnetic (TEM) mode.

TEM modes have the characteristic that their excitation spectrum is not restricted by any cut-off frequency, which means that it is possible to measure the container 7-(suspension 6 system) in a very wide frequency range.

In order to model this first microstrip conductor 2, the two dielectrics through which the electromagnetic field propagates, i.e., the container 7, suspension 6 system, on the one hand, and the dielectric material of the flexible printed circuit board 14, on the other hand, are now considered as a single homogeneous dielectric material with an effective permittivity, in which case the effective permittivity is composed of the permittivities of the two separate dielectrics.

If the structure of one of the two dielectrics changes, and thus also its permittivity, then this results in a change in the phase velocity of the electromagnetic field of the measurement signal and thus also in a measurable phase shift of the measurement signal over a given length of the first microstrip conductor.

This makes it possible to measure (local and temporal) changes in the composition of a suspension, for example, resulting from cell growth, and without subjecting the sensor to possible contamination by the suspension itself while doing so. This also makes the sensing element particularly suitable for process monitoring in industrial environments. It is also possible to simultaneously monitor the state of the container 7. In this situation, the measurement itself can be performed either directly by comparing the phase of the measurement signal fed into the sensing element 1 with the phase of the measurement signal exiting from the sensing element 1 measurement signal. Here, the measuring signal can, on the one hand, be passed unidirectionally through the first conductor strip 3, arranged in a meandering form in the present exemplary embodiment, and the phase of the transmitted portion of the measurement signal can be compared with the phase of the measurement signal fed in. On the other hand, however, it is also possible to short-circuit one end of the first conductor strip or to provide it with an open circuit, and thereby (as an exiting measurement signal) to generate a strong reflection signal of the measurement signal. This method has the advantage that the electrical length of the first microstrip conductor 2 is doubled, as a result of which the phase shift of the measurement signal is doubled. This means that either a higher measurement accuracy can be achieved or the structure of the dielectric material sample to be measured can be reduced in size. The disadvantage in this case, however, is that broadband directional couplers are required to decouple the reflection, both for the measurement signal itself and also for a reference signal if necessary.

A further possibility for the measurement is a differential method where a reference signal is fed into the second conductor strip 11 of the second microstrip conductor 10 provided for the purpose. Here, the second conductor strip 11 is shielded from the first microstrip conductor by the first ground surface 5, which results in the fact that the electromagnetic field of the reference signal is not conducted through the dielectric material sample to be measured.

This means that such a reference signal, provided that it has the same frequency as the measurement signal and provided that the second conductor strip 11 in which the reference signal is conducted has the same electrical length as the first conductor strip 3, will always experience a different phase shift than the measurement signal. Using the above-described method, the comparison of the two resulting phase shifts with each other then allows conclusions to be drawn regarding the internal composition or structure of the dielectric material sample to be measured. Here, either the transmitted portions of the measurement signal and of the reference signal can be compared with each other, or the respective reflected portions of both signals can be compared by short-circuiting both microstrip conductors 2, 10 at one end.

The sensing element 1 in accordance with the first exemplary embodiment, described in connection with FIG. 5, also functions in accordance with the same principle. However, the sensing element 1 in this embodiment is better suited, for example, for dielectric materials that are held in vessels such as tanks or silos or in bags. Due to the flexibility of the printed circuit board 4 or 12 upon which the conductor strip 3 or 11 for the measurement signal or the reference signal is arranged, the sensing element 1 in accordance with the invention can easily adapt to a wide variety of surfaces of such containers. With an adhesive device fitted away from the respective conductor strip 3, 11, the sensing element of this embodiment can, for example, be fitted in patch-like fashion from outside to the container 7.

FIG. 8 is a flowchart of the method for determining the impedance of a dielectric material sample 6 contained in a container 7 via a measurement system including a sensor element 1 and a device 13 either (i) generating and evaluating a measurement signal or (ii) a measurement signal and a reference signal for the sensing element 1.

The method comprises applying a first conductor strip 3 provided for a measurement signal from the outside and over an area to the container 7 to establish contact between the sensing element 1 and the container 7, as indicated in step 810.

Next, a measurement signal with a given frequency entering the sensing element 1 is supplied, as indicated in step 820. Next, the measurement signal exiting the sensing element 1 is measured, as indicated in step 830.

The phase shift between the entering and exiting measurement signals is now determined, as indicated in step 840.

Next, the impedance of the dielectric material sample 6 held in the container 7 from the phase shift between from the phase shift between the entering and exiting measurement signals is determined, as indicated in step 850.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A sensing element for a measurement system suitable for dielectric impedance spectroscopy, comprising:
at least one first micro strip conductor at least in an operating state of the sensing element, the at least one first microstrip conductor consisting of:
a first conductor strip for a measurement signal;
a first dielectric substrate; and
a first ground surface;
wherein the first conductor strip is applicable externally and over an area to a container containing a dielectric material sample to be measured.

17. The sensing element as claimed in claim 16, wherein the sensing element is flexible.

18. The sensing element as claimed in claim 16, wherein the sensing element is rigid, and curved at least sectionally.

19. The sensing element as claimed in claim 16, wherein the first dielectric substrate is formed by a first printed circuit board, wherein the first printed circuit board has at least one first outer surface and a second outer surface arranged parallel to the first outer surface; and wherein the first conductor strip is arranged on the first outer surface and the first ground surface is arranged on the second outer surface.

20. The sensing element as claimed in claim 17, wherein the first dielectric substrate is formed by a first printed circuit board; wherein the first printed circuit board has at least one first outer surface and a second outer surface arranged parallel to the first outer surface; and wherein the first conductor strip is arranged on the first outer surface and the first ground surface is arranged on the second outer surface.

21. The sensing element as claimed in claim 18, wherein the first dielectric substrate is formed by a first printed circuit board; wherein the first printed circuit board has at least one first outer surface and a second outer surface arranged parallel to the first outer surface; and wherein the first conductor strip is arranged on the first outer surface and the first ground surface is arranged on the second outer surface.

22. The sensing element as claimed in claim 16, wherein the sensing element comprises a second micro strip conductor consisting of a second conductor strip for a reference signal, a second dielectric substrate and a ground surface.

23. The sensing element as claimed in claim 22, wherein the ground surface of the second micro strip conductor is formed by the first ground surface.

24. The sensing element as claimed in claim 23, wherein the second dielectric substrate is formed by a second printed circuit board.

25. The sensing element as claimed in claim 24, wherein the first printed circuit board and the second printed circuit board each form a layer of a two-layer printed circuit board; and wherein the two layers of the two layer printed circuit board are separated from each other by the first ground surface.

26. The sensing element as claimed in claim 16, wherein the first conductor strip and the first ground surface are arranged beside each other on the same outer surface of a flexible printed circuit board; and wherein the first dielectric substrate in the operating state of the sensing element is formed by the container together with the dielectric material sample to be measured contained therein.

27. The sensing element as claimed in claim 26, wherein a second conductor strip is arranged on an outer surface of the same section of the flexible printed circuit board, said outer surface extending parallel to and being situated opposite the first ground surface; and wherein the second conductor strip covers the first ground surface.

28. The sensing element as claimed in claim 27, wherein the second conductor strip, the first ground surface and the section of the flexible printed circuit board arranged between the second conductor strip and the first ground surface form a second microstrip conductor.

29. The sensing element as claimed in claim 16, wherein at least one of (i) the first conductor strip and (ii) the second conductor strip is formed in a meandering shape.

30. The sensing element as claimed in claim 16, wherein the dielectric material sample is one of a pipe, a vessel and a bag.

31. A measurement system for dielectric impedance spectroscopy, comprising the sensing element as claimed in claim 16 and a device for one of (i) generating and evaluating a measurement signal (ii) a measurement signal and a reference signal for the sensing element.

32. A method for determining the impedance of a dielectric material sample contained in a container via a measurement system including a sensor element and a device for one of (i) generating and evaluating a measurement signal (ii) a measurement signal and a reference signal for the sensing element, the method comprising:
applying a first conductor strip provided for a measurement signal from the outside and over an area to the container to establish contact between the sensing element and the container;
supplying a measurement signal with a given frequency entering the sensing element;
measuring the measurement signal exiting the sensing element;
determining a phase shift between the entering and exiting measurement signals; and
determining the impedance of the dielectric material sample held in the container from the phase shift between from the phase shift between the entering and exiting measurement signals.

33. The method as claimed in claim 32, wherein in addition to the supplied measurement signal an incoming reference signal having the same frequency as the measurement signal is also fed into a second conductor strip of the sensing element provided for the reference signal, and subsequently a difference between a phase shift which the outgoing measurement signal exhibits in relation to the incoming measurement signal and the phase shift which the outgoing reference signal exhibits in relation to the incoming reference signal is determined.

34. The method as claimed in claim 32, wherein the container is a dielectric suspension.
